(19) United States
(12) Patent Application Publication
(10) Pub. No.: US 2011/0050742 A1
(43) Pub. Date: Mar. 3, 2011

(54) BACKLIGHT UNIT, DISPLAY APPARATUS AND METHOD OF CONTROLLING BACKLIGHT UNIT

(75) Inventors: Ho-seop LEE, Seongnam-si (KR); Dae-sik KIM, Hwaseong-si (KR); Dong-choon HWANG, Suwon-si (KR); Young-ji KO, Seoul (KR); Soo-bae MOON, Suwon-si (KR)

(73) Assignee: SAMSUNG ELECTRONICS CO., LTD., Suwon-si (KR)

(21) Appl. No.: 12/792,239

(22) Filed: Jun. 2, 2010

(30) Foreign Application Priority Data
Sep. 2, 2009 (KR) 10-2009-0082558

(51) Int. Cl. G09G 5/10

(52) U.S. Cl. 345/690

(57) ABSTRACT

A backlight unit, a display apparatus, and a method of controlling the backlight unit are provided. The backlight unit includes an image depth information extraction unit configured to extract image depth information from an image signal and a brightness calculator configured to calculate brightnesses corresponding to the image depth information. The backlight unitimproves three-dimensional effects on an image by controlling the brightnesses of light emitting devices according to the brightnesses calculated to correspond to image depth.

### CROSS-REFERENCE TO RELATED PATENT APPLICATION

This application claims the benefit of Korean Patent Application No. 10-2009-0082558, filed on Sep. 2, 2009, in the Korean Intellectual Property Office, the disclosure of which is incorporated herein by reference in its entirety.

### BACKGROUND

1. Technical Field

One or more embodiments relate to a backlight unit having excellent three-dimensional effects of an image, a display apparatus, and a method of controlling the backlight unit.

2. Description of the Related Art

A backlight unit is used as a light source for many applications including, but not limited to, display devices used in notebook computers, desktop computers, liquid crystal display (LCD)-TVs, mobile communication terminals, etc. For example, an LCD device, which is a flat panel display device, is a light-receiving type display device that does not emit light itself so as to form an image. Thus, a backlight unit is necessary in such an LCD device. In general, a backlight unit is disposed on the back surface of a display device so as to emit light.

The backlight unit may be classified based on the alignment of a light source. For example, a direct light type backlight unit emits light from a plurality of light sources installed right under the LCD device onto an LCD panel and an edge light type backlight unit emits light from a light source installed on a side wall of a light guide panel (LGP) onto an LCD panel. As a light source, a cold cathode fluorescent lamp (CCFL) is generally, but not always, used in the backlight unit. Further, a light emitting diode (LED) may also be used instead of the CCFL.

### SUMMARY

An illustrative embodiment provides a backlight unit having excellent three-dimensional effects on an image.

An illustrative embodiment also provides a display apparatus having excellent three-dimensional effects on an image.

An illustrative embodiment also provides a method of controlling the backlight unit having excellent three-dimensional effects on an image.

According to an illustrative embodiment, there is provided a backlight unit including: light emitting devices for emitting light; an image depth information extraction unit for extracting image depth information from an image signal; a brightness calculator for calculating brightness from the image depth information; and a controller for controlling the brightness of the light emitting devices according to the calculated brightness.

The light emitting devices may be controlled in a block unit including a plurality of adjacent light emitting devices.

The controller may control the brightness of the light emitting devices by adjusting a voltage applied to the light emitting devices.

The controller may control the brightness of the light emitting devices using pulse width modulation (PWM).

The brightness calculator may partition an image into a plurality of regions and calculates the brightness of each region.

The brightness calculator may calculate the brightness such that as the image depth increases, the brightness decreases, and as the image depth decreases, the brightness increases.

According to another illustrative embodiment, there is provided a display apparatus including: an image board for generating an image signal; a display panel for displaying an image according to the image signal generated by the image board; light emitting devices for emitting light to the display panel; an image depth information extraction unit for extracting image depth information from the image signal from the image board; a brightness calculator for calculating the brightness from the image depth information; and a controller for controlling the brightness of the light emitting devices according the calculated brightness.

According to another illustrative embodiment, there is provided a method of controlling a backlight unit, the method including: extracting image depth information from an image signal; calculating the brightness of a plurality of image regions according to the image depth information; and controlling the brightness of the light emitting devices so as to correspond to the calculated brightness.

The calculating the brightness may include using a look-up table corresponding to the image depth information.

The extracting the image depth information may include partitioning an image depth distribution area into a plurality of regions.

The controlling the brightness of the light emitting devices may include partitioning an image into a plurality of regions, and calculating the brightness of each region.

### BRIEF DESCRIPTION OF THE DRAWINGS

The above and other features and advantages will become more apparent by describing illustrative embodiments in detail with reference to the attached drawings, in which:

FIG. 1 schematically illustrates a layered structure of a display apparatus according to an illustrative embodiment;

FIG. 2 is a block diagram of a display apparatus according to an illustrative embodiment;

FIG. 3A shows an image used in a display apparatus according to an illustrative embodiment;

FIGS. 3B, 3C, and 3D are images for describing a process of extracting depth information and brightness information from the image of FIG. 3A;

FIG. 4 schematically shows a backlight unit according to an illustrative embodiment; and

FIG. 5 is a flowchart illustrating a method of controlling the backlight unit, according to an illustrative embodiment.

### DETAILED DESCRIPTION

Hereinafter, a backlight unit, a display apparatus, and a method of controlling the backlight unit according to illustrative embodiments will be described more fully with reference to the accompanying drawings.

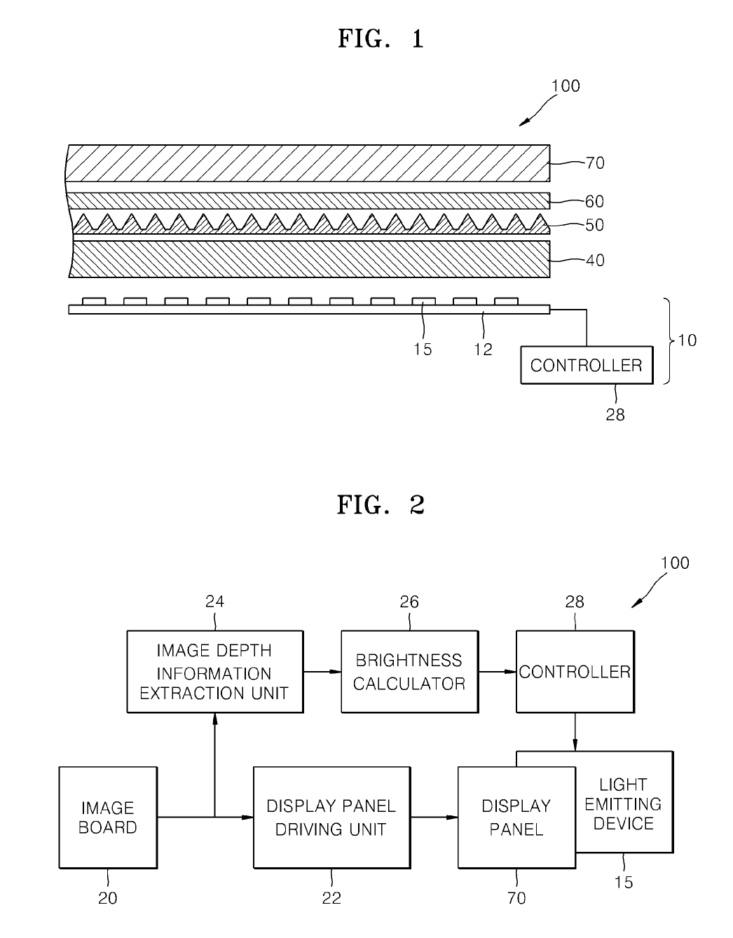

FIG. 1 schematically illustrates a layered structure of a display apparatus 100 according to an illustrative embodiment. FIG. 2 is a block diagram of the display apparatus 100 according to an illustrative embodiment.

Referring to FIGS. 1 and 2, the display apparatus 100 includes a backlight unit 10 for emitting light, and a display panel 70 which uses light emitted by the backlight unit 10 to display an image.

The display panel 70 may be, but is not limited to, a liquid crystal display (LCD) panel. The display panel 70, which includes pixel units that each include a thin film transistor and an electrode, displays an image by transmitting an electric field to each pixel of the display panel 70 according to an image signal input by an image board 20, and modulates light emitted by the backlight unit 10.

The backlight unit 10 may include light emitting devices 15 and a controller 28 that controls the light emitting devices 15. The light emitting devices 15 may be, but is not limited to, a light emitting diode (LED). A diffusion plate 40 for uniformly diffusing light emitted by the light emitting devices 15 to be incident into the display panel 70 and a prism sheet 50 for guiding light to the display panel 70 by adjusting an optical path may be disposed between the light emitting devices 15 and the display panel 70. A polarization improving film 60 may be disposed between the prism sheet 50 and the display panel 70 to improve light efficiency by improving polarization. However, the layered structure of the display apparatus 100 is not limited to that shown in FIG. 1, and a variety of layers may be disposed between the light emitting devices 15 of the backlight unit 10 and the display panel 70.

The backlight unit 10 may include light emitting devices 15 that are two-dimensionally aligned on a substrate 12 and the controller 28 that controls the light emitting devices 15. The substrate 12 may include a printed circuit board (PCB) substrate.

Referring to FIG. 2, when the image board 20 outputs an image signal, the image signal is input to a display panel driving unit 22 and an image depth information extraction unit 24. The display panel driving unit 22 generates a display panel driving signal according to the image signal to operate the display panel 70. According to the display panel driving signal, the display panel 70 is operated by an on-off switch of each pixel. The display panel driving unit 22 may include information about a voltage applied to each pixel of the display panel 70. For example, the transmittance of light emitted by the light emitting devices 15 of the backlight unit 10 may be controlled by adjusting the voltage applied to each pixel of the display panel 70 so as to represent an image in gray scale.

The image depth information extraction unit 24 extracts image depth information from the image signal output by the image board 20. For example, if the image signal includes a two-dimensional image and image depth information, the image depth information extraction unit 24 may extract the image depth information without calculating the image depth. In a stereoscopic image, the image depth is calculated from the image signal. For example, the image depth information may be extracted from a two-dimensional image by mixing predetermined depth models according to color information of an input image. Such a method is disclosed in Pseudo 3D Image Generation width Simple Depth Models, 2005 IEEE. The image depth information may be extracted from a stereoscopic image by calculating a disparity map by comparing feature points such as edges, lines, and corners. Such a method is disclosed in Edge-Preserving Directional Regularization Technique For Disparity Estimation of Stereoscopic Images, IEEE Transaction on Consumer Electronics, Vol. 45, No. 3, August 1999, pp. 804-810.

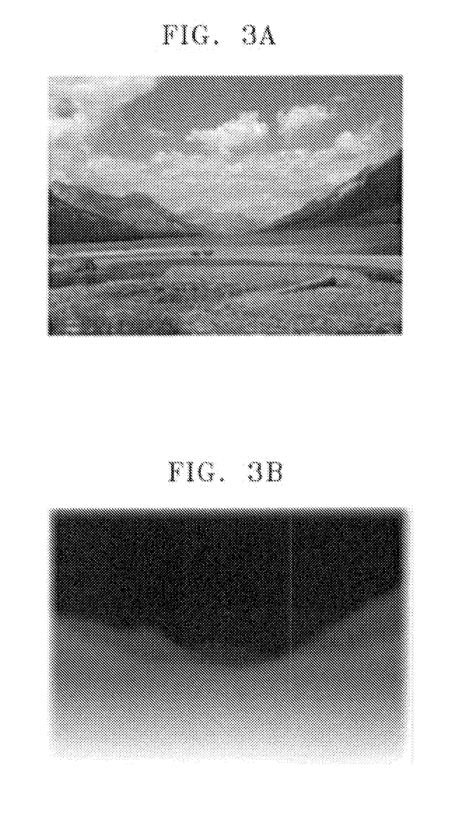

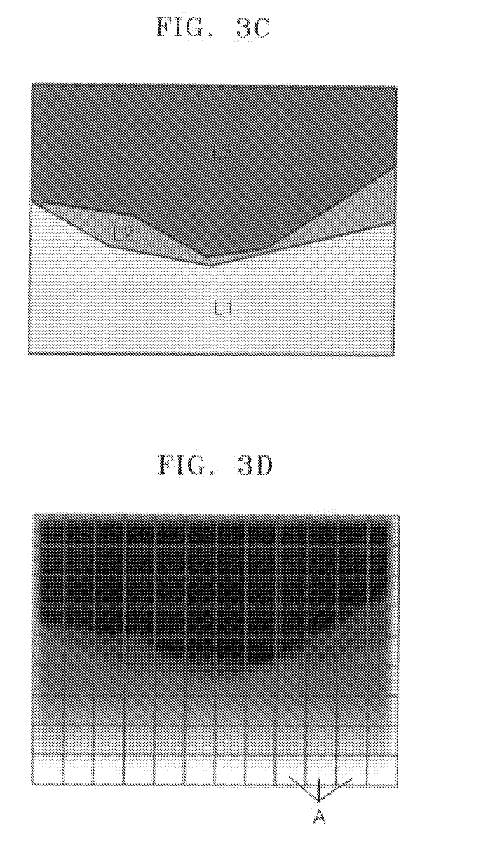

For example, when the image shown in FIG. 3A is displayed, the image depth information extracted from the image of FIG. 3A is shown in FIG. 3B. As image depth decreases, the image appears closer to white in color, and as image depth increases, the image appears closer to black in color. In other words, as the distance between an observer and the image decreases, the image appears closer to white in color, and as the distance between the observer and the image increases, the image appears closer to black in color.

FIG. 3C is an image partitioned into a plurality of regions, for example, a first region L1, a second region L2, and a third region L3, according to the image depth information. When the image of FIG. 3A is compared with the image depth distribution of FIG. 3C, the lake shown in FIG. 3A, which is the closest to the observer, corresponds to the first region L1 of FIG. 3C, a region in the middle of the image corresponds to the second region L2, and the sky, which is the farthest from the observer, corresponds to the third region L3. For example, a part of the image in the first region L1 may have first image depth information, and a part of the image in the second region L2 may have second image depth information and a part of the image in the third region L3 may have third image depth information. In this regard, if a resolution of the image depth is referred to as a bit, the first region L1, the second region L2, and the third region L3 may be shown in gray scale. For example, the image depth information of each region may be distributed in gray scale between white (255) and black (0).

The image depth distribution area may be partitioned into a plurality of regions according to the number of light emitting devices 15. For example, the image depth information extraction unit 24 may partition the image into a plurality of brightness distribution regions A as shown in FIG. 3D, and may extract depth information of each brightness distribution region A using an averaging operation.

After the depth information is extracted by the image depth information extraction unit 24, a brightness calculator 26 calculates a brightness corresponding to each piece of depth information. The brightness calculator 26 may include a look-up table corresponding to each piece of depth information. The brightness calculator 26 may include a reference value for calculating brightness according to the depth information. Based on the reference value, a region in which brightness is required to be adjusted may be extracted.

According to the brightness obtained by the brightness calculator 26, the controller 28 controls the brightness of the light emitting devices 15. The light emitting devices 15 may be each independently electrically operated, and the brightness of the light emitting devices 15 may be controlled based on the brightness distribution. For example, if an image has a brightness distribution as shown in FIG. 3C, the brightness of the light emitting devices 15 located in a region corresponding to the first region L1 is controlled to L1b, the brightness of the light emitting devices 15 located in a region corresponding to the second region L2 is controlled to L2b, and the brightness of the light emitting devices 15 located in a region corresponding to the third region L3 is controlled to L3b. In this regard, when the depth of each region satisfies the relation of the depth of the first region L1<the depth of the second region L2<the depth of the third region L3, the brightness of light emitting devices corresponding to each region may be controlled to satisfy the relation of L1b>L2b>L3b.

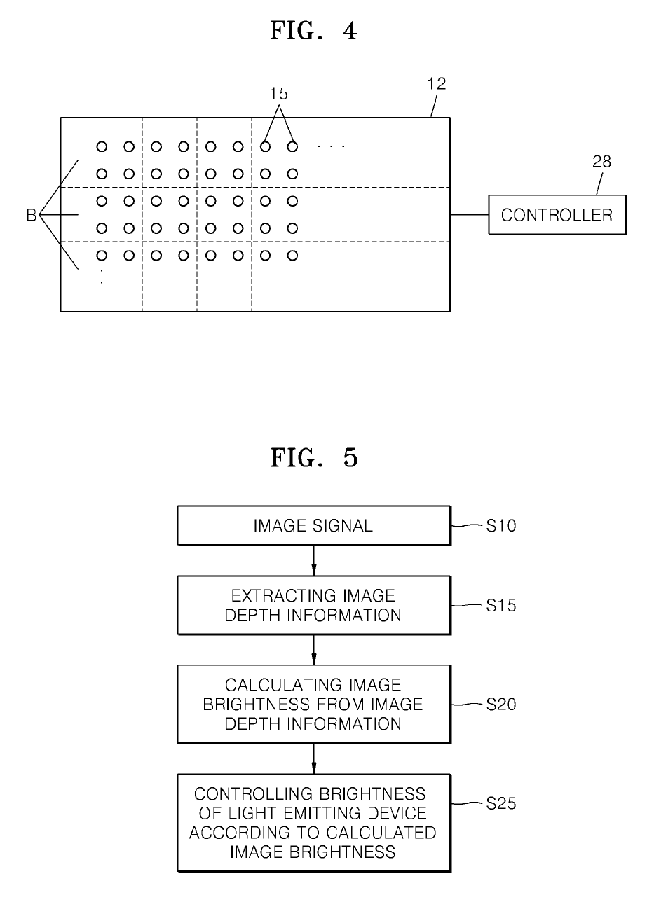

The light emitting devices 15 may be each independently controlled. Alternatively, as shown in FIG. 4, a block B including a plurality of adjacent light emitting devices 15 may be controlled.

The light emitting devices 15 may be two-dimensionally aligned on the substrate 12 as shown in FIG. 4 and partitioned into a plurality of blocks B, wherein the blocks B may be each independently controlled. The plurality of blocks B may correspond to, for example, the brightness distribution regions A of the brightness calculator 26 as shown in FIG. 3D. The number of light emitting devices 15 contained in the blocks B is not limited. FIG. 4 shows four light emitting device 15 in blocks B, but FIG. 4 is merely an illustrative embodiment.

The light emitting devices 15 may be disposed on a PCB substrate 12 and have a circuit by which current is supplied independently to the light emitting devices 15. The controller 28 may control current supplied to, or voltage applied to, each of the light emitting devices 15 using a digital-to-analog (D/A) converter. Or, the brightness of the light emitting devices 15 may be controlled by adjusting current supplied to, or voltage applied to, the light emitting devices 15 of each block B using a D/A converter. For example, the perspective of an image may be improved by supplying relatively greater or less current to the light emitting devices 15 located in the regions with high brightness than to the light emitting devices 15 located in the regions with low brightness, and thus three-dimensional effects of the image may be improved.

Alternatively, the controller 28 may control the brightness of the light emitting devices 15 using a pulse width modulation (PWM).

According to an illustrative embodiment, the light emitting devices 15 may each be a multi-chip light emitting device including a plurality of light emitting diodes that emit lights having at least two wavelength ranges and are formed in a single package. Light having different wavelengths emitted by a light emitting diode chip are totally reflected internally to create a white light. The number of light emitting diode chips of each wavelength and the alignment thereof may vary according to a range for a desired color temperature in consideration of the amount of light emitted by the light emitting diode chip of each wavelength. As described above, since the size of the multi-chip light emitting device is not significantly changed when compared with that of the single-chip light emitting device, the volume of the multi-chip light emitting device is also not changed substantially. In addition, since color-mixing for the color white is performed in the light emitting devices 15, the space for the color-mixing is significantly reduced, thereby decreasing the thickness of the backlight unit 10.

The light emitting devices 15 may each also be a single-chip light emitting device, and light emitting devices 15 emitting lights having different wavelengths may be alternately aligned. For example, a first light emitting device emitting a light having a first wavelength, a second light emitting device emitting a light having a second wavelength, and a third light emitting device emitting a light having a third wavelength may be disposed on the PCB substrate 12 and separated by a predetermined distance. In this regard, only one first light emitting device, one second light emitting device, and one third light emitting device are alternately aligned herein. However, if an amount of one of the lights having different wavelengths is required to be increased; two chips for emitting the light may be continuously aligned. For example, the amount of green light may be increased by aligning a red light emitting device, a green light emitting device, a green light emitting device, and a blue light emitting device.

Alternatively, the light emitting devices 15 may constitute a single chip including fluorescent materials. A white light may be emitted by mixing light emitted from the single chip and light emitted from the fluorescent material excited by light emitted from the single chip. The fluorescent materials for light emitting devices to form a white light are well known in the art, and thus description thereof will be omitted herein.

FIG. 5 is a flowchart illustrating a method of controlling the backlight unit 10, according to an illustrative embodiment.

In operation S10, an image signal is generated in the image board 20 (FIG. 1), and in operation S15, image depth information is extracted from the image signal.

The brightness of the image is calculated from the image depth information in operation S20. As image depth increases, the brightness decreases, and as image depth decreases, the brightness increases. The brightness calculator 26 may include a look-up table or a reference value corresponding to the image depth information to calculate the brightness information. The brightness calculator 26 may partition the image into a plurality of brightness distribution regions. In operation S25, the brightness of the light emitting devices 15 in regions corresponding to the plurality of brightness distribution regions are controlled according to the calculated image brightness. The brightness may be controlled according to the image depth to improve three-dimensional effects. A method of controlling the brightness of the light emitting device may be classified into a method of controlling the brightness of each of the light emitting devices 15 and a method of controlling the brightness of a block including a plurality of the light emitting devices 15.

As described above, the backlight unit 10 and the display apparatus 100 using the backlight unit 10 control the brightness of the light emitting devices 15 according to the image depth information to improve three-dimensional effects. The three-dimensional effects may be improved by processing the image signal without using a separate device. Furthermore, since the brightness of the light emitting devices 15 is controlled by the perspective of the image, power consumption may be reduced compared with light emitting devices maintaining a constant brightness. According to an illustrative embodiment of the method of controlling the backlight unit 10, the light emitting devices 15 are controlled by extracting the image depth information from the image signal and extracting the brightness of the image from the image depth information. Thus, three-dimensional effects based on the perspective of the image may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A backlight unit comprising:
light emitting devices configured to emit light;
an image depth information extraction unit configured to extract image depth information corresponding to an image signal;
a brightness calculator configured to calculate brightnesses corresponding to the image depth information; and
a controller configured to control brightnesses of the light emitting devices according to the calculated brightnesses.

2. The backlight unit of claim 1, wherein the controller is configured to control the light emitting devices in a block unit comprising a plurality of adjacent light emitting devices.

3. The backlight unit of claim 1, wherein the controller is configured to control the brightnesses of the light emitting devices by adjusting voltages applied to the light emitting devices.

4. The backlight unit of claim 1, wherein the controller is configured to control the brightnesses of the light emitting devices using pulse width modulation (PWM).

5. The backlight unit of claim 1, wherein the brightness calculator is configured to partition an image into a plurality of regions and calculate a brightness of each of the plurality of regions.

6. The backlight unit of claim 1, wherein the brightness calculator is configured to calculate brightnesses such that as image depth increases, calculated brightness decreases, and as image depth decreases, calculated brightness increases.

7. A display apparatus comprising:
an image board configured to generate an image signal;
a display panel configured to display an image according to the image signal generated by the image board;
light emitting devices configured to emit light to the display panel;
an image depth information extraction unit configured to extract image depth information from the image signal generated by the image board;
a brightness calculator configured to calculate brightnesses corresponding to the image depth information; and
a controller configured to control brightnesses of the light emitting devices according the calculated brightnesses.

8. The display apparatus of claim 7, wherein the controller is configured to control the light emitting devices in a block unit comprising a plurality of adjacent light emitting devices.

9. The display apparatus of claim 7, wherein the controller is configured to control the brightnesses of the light emitting devices by adjusting voltages applied to the light emitting devices.

10. The display apparatus of claim 7, wherein the controller is configured to control the brightnesses of the light emitting devices using pulse width modulation (PWM).

11. The display apparatus of claim 7, wherein the brightness calculator is configured to partition an image into a plurality of regions and calculate a brightness of each of the plurality of regions.

12. The display apparatus of claim 7, wherein the brightness calculator is configured to calculate brightnesses such that as image depth increases, calculated brightness decreases, and as image depth decreases, calculated brightness increases.

13. A method of controlling a backlight unit, the method comprising:
extracting image depth information from an image signal;
calculating brightnesses of a plurality of image regions according to the image depth information; and
controlling brightnesses of light emitting devices to correspond to the calculated brightnesses.

14. The method of claim 13, wherein the calculating the brightnesses is performed such that as image depth increases, calculated brightness decreases, and as image depth decreases, calculated brightness increases.

15. The method of claim 13, wherein the calculating the brightnesses comprises using a look-up table corresponding to the image depth information.

16. The method of claim 13, wherein the extracting the image depth information comprises partitioning an image depth distribution area into a plurality of regions.

17. The method of claim 13, wherein the controlling the brightnesses of the light emitting devices comprises controlling the light emitting devices in a block unit comprising a plurality of adjacent light emitting devices.

18. The method of claim 13, wherein the controlling the brightnesses of the light emitting devices comprises controlling the brightnesses by adjusting voltages applied to the light emitting devices.

19. The method of claim 13, wherein the controlling the brightnesses of the light emitting devices comprises controlling the brightnesses using pulse width modulation (PWM).

20. The method of claim 13, wherein the controlling the brightnesses of the light emitting devices comprises partitioning an image into a plurality of regions, and calculating a brightness of each of the plurality of regions.

21. A display apparatus comprising:
a plurality of light emitters configured to display an image;
an image depth information generation unit configured to generate image depth information corresponding to the image; and
a brightness control unit configured to control a brightness of light emitted from each one of the plurality of light emitters in accordance with said generated image depth information.

22. The display apparatus of claim 21, wherein the generated image depth information comprises information regarding a first region of the image and a second region of the image;
wherein the first region has a greater image depth than the second region;
wherein a first one of the light emitters emits first light for displaying the first region;
wherein a second one of the light emitters emits second light for displaying the second region; and
wherein the brightness control unit is configured to control a brightness of the emitted first light to be less than a brightness of the second light.

23. A method of controlling a display apparatus, the method comprising:
generating image depth information corresponding to an image;
displaying the image by controlling a brightness of light emitted from each one of a plurality of light emitters in accordance with said generated image depth information.

24. The method of claim 23, wherein the generating image depth information comprises generating information regarding a first region of the image and a second region of the image,
wherein the first region has a greater image depth than the second region, and
wherein the displaying the image comprises:
controlling a first one of the light emitters to emit first light for displaying the first region;
controlling a second one of the light emitters to emit second light for displaying the second region; and
controlling a brightness of the first light to be less than a brightness of the second light.
